(19) United States
(12) Patent Application Publication
(10) Pub. No.: US 2013/0162119 A1
(43) Pub. Date: Jun. 27, 2013

(54) STORAGE HOUSING FOR A WASTE RECEPTACLE

(71) Applicant: Nicholas Staley, Wokingham (GB)

(72) Inventor: Nicholas Staley, Wokingham (GB)

(21) Appl. No.: 13/820,990

(22) PCT Filed: Aug. 19, 2011
(86) PCT No.: PCT/GB11/51573

§ 371 Date: Mar. 5, 2013

(30) Foreign Application Priority Data
Sep. 6, 2010 (GB) 1014759.3

(51) Int. Cl. B65F 1/14; B65F 7/00

(52) U.S. Cl. CPC B65F 1/1426; B65F 7/00
USPC 312/211

(57) ABSTRACT

A storage housing (10) for a waste receptacle (11) is disclosed. The housing comprises a base (12)and side walls (13a-d)which extend from the base(12), and which terminate at an upper periphery (14) thereof. At least one of the side walls (13a) comprise a door (21) which can be opened and closed to enable the waste receptacle (11) to be removably positioned within the housing (10) through the at least one side wall (13a).The housing (10) further comprises locking means for releasably locking the door (21) when closed and a lid (16) which is moveable with respect to the side walls (13a - d) between a first position in which it substantially closes the housing (10) and a second position in which it substantially opens the housing (10) to enable waste to be deposited in the waste receptacle (11).

The present invention relates to a storage housing for a waste receptacle and particularly, but not exclusively, to a storage housing for a so-called “wheelie bin”.

It is known to position refuse sacks outside properties for collection and disposal by the local authorities. However, these refuse sacks are unsightly, attract vermin and often become broken by animals resulting in the spill of refuse therefrom. Accordingly, it is common for refuse sacks to be positioned in so-called “wheelie-bins”, which serve to retain the waste until collection.

The wheelie-bins however can similarly detract from the visual appearance of a property and often produce unpleasant odours, owing to the storage of waste in a confined space. Moreover, it is common for wheelie-bins to become stolen, thereby necessitating the purchase of a further bin.

I have now devised a storage housing for a waste receptacle, which alleviates the above-mentioned problems.

In accordance with the present invention there is provided a storage housing for a waste receptacle, the housing comprising a base and side walls which extend from the base, and which terminate at an upper periphery thereof, at least one of the side walls comprising a door which can be opened and closed to enable the waste receptacle to be removably positioned within the housing through the at least one side wall,

the housing further comprising locking means for releasably locking the door when closed and a lid which is moveable with respect to the side walls between a first position in which it substantially closes the housing and a second position in which it substantially opens the housing to enable waste to be deposited within the housing.

The storage housing thus enables a wheelie bin to be lockably secured therein, while also enabling waste to be deposited in the bin without having to remove the bin from the housing.

The locking means preferably comprises a key-operated lock or similar.

Preferably, the lid is arranged to accommodate plants. The lid is preferably tray-shaped and is arranged to hold soil and the like for growing plants. The lid preferably further comprises a drainage arrangement permitting excess water within the lid to drain from the lid.

Preferably, the lid is slidably mounted with respect to the side walls and is preferably lockable in the first position by further locking means.

Preferably, the housing comprises means for opening and closing the waste receptacle in accordance with the movement of the lid. The means for opening and closing the waste receptacle is preferably arranged to open the receptacle as the lid moves from the first position to the second position. The means for opening and closing the waste receptacle is preferably arranged to close the receptacle as the lid moves from the second position to the first position.

The means for opening and closing the waste receptacle preferably comprises a linkage which is securable at one end to the lid and at the other end to a cover of the waste receptacle.

Preferably, the housing further comprises means for stabilising the housing. The stabilising means preferably comprises an anchor which is arranged to pass into the ground. Alternatively, or in addition thereto, the stabilising means may comprise or further comprise brackets enabling the housing to be secured to a wall or similar.

The housing preferably further comprises means for dispensing a scent into the housing. Preferably, the means for dispensing a scent comprises a spray gun which is arranged to dispense the scent into the housing.

Preferably, the housing comprises a sensor for sensing movement of the lid. The means for dispensing scent is arranged to dispense scent in accordance with the sensed movement of the lid.

The housing preferably further comprises illumination means for illuminating the waste receptacle. Preferably, the housing further comprises an ambient light sensor for sensing the levels of ambient light and a motion sensor for sensing the presence of a user. The illuminating means is preferably arranged to operate in dependence of signals received from the light sensor and the motion sensor, such that when the light sensor senses that the light levels are below a threshold level and the motion sensor senses the presence of a user, the illuminating means is arranged to illuminate the waste receptacle.

An embodiment of the present invention will now be described by way of example only and with reference to the accompanying drawings, in which:

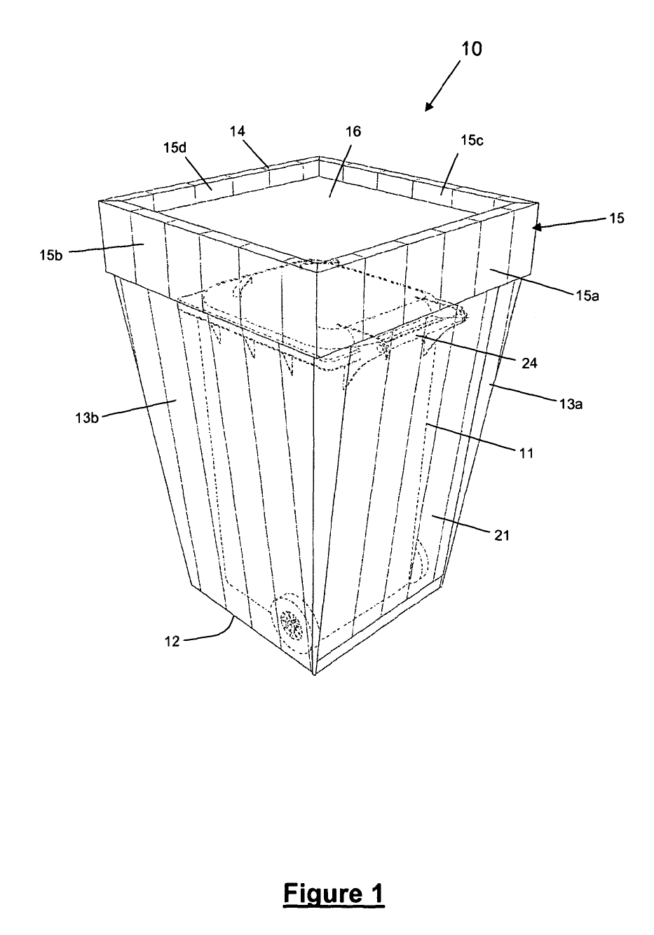

FIG. 1 is a perspective view of the storage housing according to an embodiment of the present invention, with a wheelie bin positioned therein;

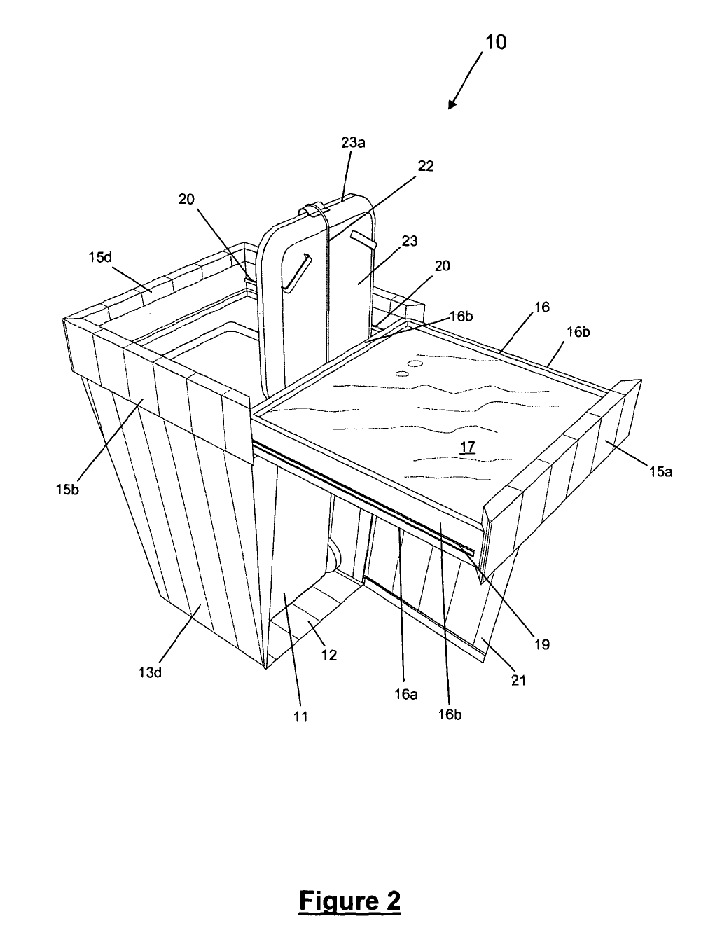

FIG. 2 is a perspective view of the storage housing illustrated in FIG. 1, with the lid and door opened;

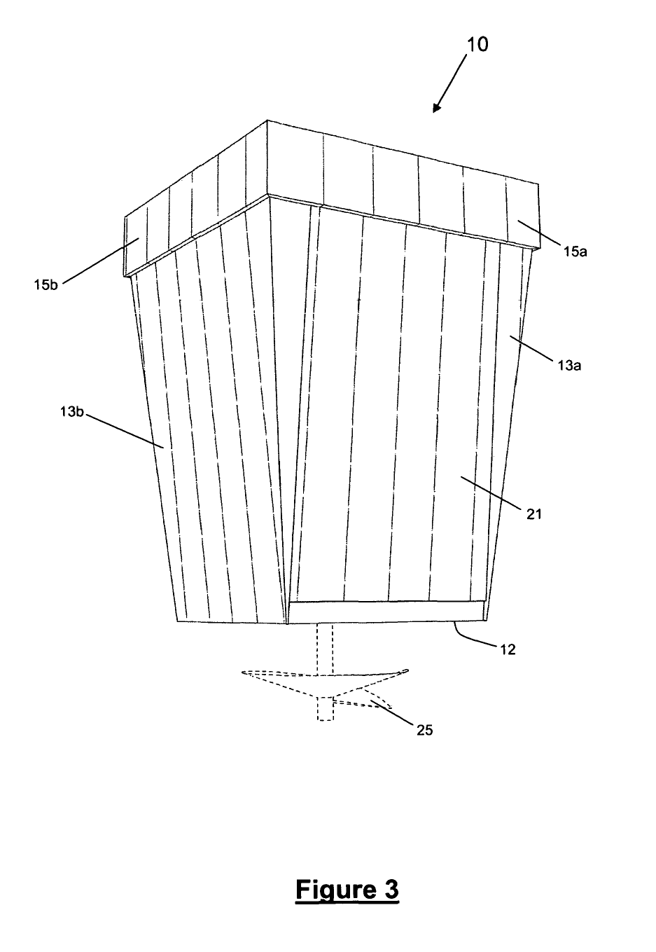

FIG. 3 is a perspective view of the storage housing illustrated in FIG. 1, illustrating an anchor for stabilising the housing; and,

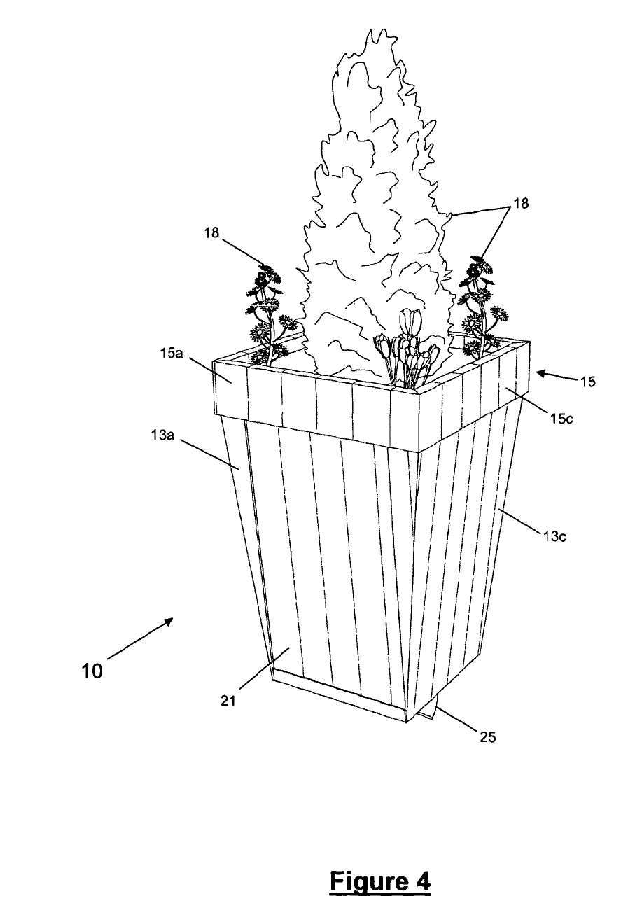

FIG. 4 is a perspective view of the storage housing illustrated in FIG. 1, with plants positioned within the lid.

Referring to FIGS. 1 and 2 of the drawings, there is illustrated a storage housing 10 for a waste receptacle, such as a waste refuse sack or a wheelie bin 11, according to an embodiment of the present invention.

The storage housing 10 comprises a substantially square base 12, and side walls 13a-d which extend from the periphery of the base 12 and which diverge away from each other toward an open upper periphery 14 of the housing 10. The upper periphery 14 of the housing 10 comprises a collar 15 having a first, second, third and fourth collar panel 15a-d, which separately extend along the upper region of each side wall 13a-d. The housing 10 further comprises a lid 16 which is moveable within the collar 15 to open and close the housing 10 at the upper region thereof.

The lid 16 comprises a bottom section 16a and upstanding side walls 16b which extend from the periphery of the bottom section 16a, to form a substantially tray-like shape. The lid 16 is arranged to accommodate soil and compost 17 and the like for enabling plants 18 to grow therein. The lid 16 further comprises a drainage arrangement (not shown) comprising a plurality of drainage holes (not shown) disposed in the bottom section 16a thereof, to enable excess water within the lid 16 to drain therefrom. The drainage arrangement (not shown) may further comprise a ducting arrangement (not shown) for collecting water that passes through the drainage holes (not shown) and for passing the water out from the housing 10.

The lid 16 further comprises a runner 19 (only one of which is illustrated in the drawings) disposed in two opposing side walls 16b, which are separately arranged to cooperate with a track 20 disposed in two opposing collar panels, for example the second and third collar panel 15b, 15c. The runners 19 and tracks 20 are arranged to enable the lid 16 to slide into and out from the collar 15 of the housing 10 to open and close the housing, and thus permit waste (not shown) to be deposited in a waste receptacle, such as a wheelie bin 11 positioned within the housing 10. In this respect, one of the collar panels, for example a first collar panel 15a which extends between the second and third opposing collar panels 15b, 15c, forms one of the upstanding side walls 16b of the lid 16 or is otherwise secured to one of the side walls 16b of the lid 16. The lid further comprises locking means such as a key-operated lock (not shown), for locking the lid when closed.

The housing 10 further comprises a door 21 disposed in one of the side walls 13a thereof, which permits the waste receptacle, such as a wheelie bin 11, to be removably positioned within the housing 10. The door 21 is arranged in the housing 10 at the side from which the lid 16 is arranged to extend, and is hingedly coupled along one side edge thereof to the side wall 13a, such that the door 21 can be rotated to open and close the side wall 13a of the housing 10. The door 21 further comprises a lock (not shown), such as a padlock, for locking the door 21 in the closed configuration and to thus minimise potential theft of the bin 11.

The housing 10 further comprises a linkage, such as a tether 22, which is securable at one end to the lid 16 and at the other end to a cover 23 of the wheelie bin 11. The cover 23 is hingedly coupled to the bin 11 at hinge 24 and the tether 22 is securable to the cover 23 at the free side 23a thereof which is opposite the hinge 24. In this manner, when the bin 11 is positioned within the housing 10 and the linkage 22 suitably coupled to the cover 23 and lid 16, then as the lid 16 is moved to open the housing 10, the cover 23 is arranged to pivot about the hinge 24 to open the bin 11.

The housing 10 further comprises a scent dispenser, such as a spray gun (not shown) or deodorising canister (not shown), disposed therein for releasing an aromatic scent to suppress any unpleasant odours which emanate from the bin 11 and/or refuse sacks positioned within the housing 10. The scent dispenser (not shown) may be manipulated by a user (not shown) to dispense the scent as required. Alternatively, or in addition thereto, the scent dispenser (not shown) may be arranged to dispense scent in accordance with the movement of the lid 16. In this embodiment, it is envisaged that the housing 10 may comprise a sensor (not shown) disposed upon the housing 10 to sense movement of the lid 16, such that as the lid 16 moves to the open position, the sensor (not shown) is arranged to cause the scent dispenser (not shown) to dispense scent into the housing 10.

The housing further comprises a light (not shown) or similar disposed upon the lid 16 for illuminating the waste receptacle 11 when depositing waste therein at night for example. The light (not shown) is arranged to operate in dependence of signals received from an ambient light sensor (not shown) and a motion sensor (not shown), such that when the light sensor (not shown) senses that the levels of ambient light have reduced to a level below a threshold value and the motion sensor (not shown) senses the presence of a user (not shown), the light (not shown) is arranged to illuminate to assist the user in depositing waste. Once the sensor detects the absence of the user, namely no motion, or after a pre-determined time lapse, the light (not shown) is then arranged to switch off.

Referring to FIG. 3 of the drawings, the housing 10 further comprises an anchor 25, disposed at the underside of the base 12, which may be in the form of a screw for example, and which is arranged to extend into the ground. It is found that when the lid 16 is moved to open the housing 10, the weight of the lid 16 and any soil 17 and plants 18 disposed therein, can cause the housing 10 to topple over. The anchor 25 is thus arranged to stabilise the housing 10 and maintain the housing 10 in a suitable upright orientation. If required, the housing 10 may be further stabilised using brackets (not shown) disposed on the side walls 13 of the housing 10. The brackets (not shown) permit the housing 10 to be coupled directly to a wall (not shown) by passing fasteners (not shown), for example screws, through the brackets (not shown) into the wall (not shown).

In use, a user (not shown) first stabilises the housing 10 by forcing the anchor 25 into the ground and/or by using the brackets (not shown). The user (not shown) may then fill the lid 16 with soil and compost 17, for example and then position plants 18 within the soil 17 to provide for an attractive feature, as illustrated in FIG. 4 of the drawings. The plants 18 are found to further provide an aromatic scent which helps suppress any unpleasant odours. The user (not shown) subsequently opens the door 21, wheels the bin 11 into the housing 10 and then locks the door 21 in the closed configuration to securely house the bin 11, and thus remove the bin from view.

The lid 16 is then unlocked and moved to open the housing 10 and expose the cover 23 to the bin 11, and the tether 22 is coupled at one end to the free side 23a of the cover 23 and at the other end to the lid 16, such that when the lid 16 is subsequently moved from the closed position to the open position, the tether 22 causes the cover 23 to move to open the bin 11 and thus enable a user (not shown) to deposit waste within the bin 11. Simultaneously, the movement of the lid is sensed by the sensor (not shown), which causes the scent dispenser (not shown) to dispense an aromatic scent into the housing 10 and thus suppress any unpleasant odours which emanate therefrom. If required, the user (not shown) may dispense further scent by manipulating the scent dispenser (not shown). The user may then close the lid 16 and lock the lid 16 in the closed configuration to secure the housing.

Once the bin 11 has been suitably filled, the lid 16 is unlocked and moved to the open position to expose the tether 22, which is then uncoupled from the free side 23a of the cover 23. The door 21 is then unlocked and opened to enable the bin 11 to be removed for emptying.

What is claimed is:

1. A storage housing for a waste receptacle, the housing comprising a base and side walls which extend from the base, and which terminate at an upper periphery thereof, at least one of the side walls comprising a door which can be opened and closed to enable the waste receptacle to be removably positioned within the housing through the at least one side wall,
the housing further comprising locking means for releasably locking the door when closed and a lid which is moveable with respect to the side walls between a first position in which it substantially closes the housing and a second position in which it substantially opens the housing to enable waste to be deposited within the housing.

2. A storage housing according to claim 1, wherein the locking means comprises a key-operated lock.

3. A storage housing according to claim 1, wherein the lid is arranged to accommodate plants.

4. A storage housing according to claim 1, wherein the lid is tray-shaped and is arranged to hold soil and the like for growing plants.

5. A storage housing according to claim 3, wherein the lid further comprises a drainage arrangement permitting excess water within the lid to drain from the lid.

6. A storage housing according to claim 1, wherein the lid is slidably mounted with respect to the side walls.

7. A storage housing according to claim 1, wherein the lid is lockable in the first position by further locking means.

8. A storage housing according to claim 1, wherein the housing comprises means for opening and closing the waste receptacle in accordance with the movement of the lid.

9. A storage housing according to claim 8, wherein the means for opening and closing the waste receptacle is arranged to open the receptacle as the lid moves from the first position to the second position.

10. A storage housing according to claim 8, wherein the means for opening and closing the waste receptacle is arranged to close the receptacle as the lid moves from the second position to the first position.

11. A storage housing according to claim 8, wherein the means for opening and closing the waste receptacle comprises a linkage which is securable at one end to the lid and at the other end to a cover of the waste receptacle.

12. A storage housing according to claim 1, further comprises means for stabilising the housing.

13. A storage housing according to claim 12, wherein the stabilising means comprises an anchor which is arranged to pass into the ground.

14. A storage housing according to claim 12, wherein the stabilising means comprises or further comprises brackets enabling the housing to be secured to a wall or ground or similar.

15. A storage housing according to claim 1, further comprising means for dispensing a scent into the housing.

16. A storage housing according to claim 15, wherein the means for dispensing a scent comprises a spray gun which is arranged to dispense the scent into the housing.

17. A storage housing according to claim 1, wherein the housing comprises a sensor for sensing movement of the lid.

18. A storage housing according to claim 17, further comprising means for dispensing a scent into the housing, wherein the means for dispensing scent is arranged to dispense scent in accordance with the sensed movement of the lid.

19. A storage housing according to claim 1, further comprises illumination means for illuminating the waste receptacle.

20. A storage housing according to claim 19, further comprising an ambient light sensor for sensing the levels of ambient light and a motion sensor for sensing the presence of a user.

21. A storage housing according to claim 20, wherein the illuminating means is arranged to operate in dependence of signals received from the light sensor and the motion sensor, such that when the light sensor senses that the light levels are below a threshold level and the motion sensor senses the presence of a user, the illuminating means is arranged to illuminate the waste receptacle.
